(19) United States
(12) Patent Application Publication
(10) Pub. No.: US 2023/0064653 A1
(43) Pub. Date: Mar. 2, 2023

(54) TRANSMISSION PARAMETER SIGNALING FOR HIGHER ORDER MODULATION

(71) Applicant: QUALCOMM Incorporated, San Diego, CA (US)

(72) Inventors: Ahmed Elshafie, San Diego, CA (US); Muhammad Sayed Khairy Abdelghaffar, San Jose, CA (US); Krishna Kiran Mukkavilli, San Diego, CA (US)

(21) Appl. No.: 17/459,899

(22) Filed: Aug. 27, 2021

(51) Int. Cl. H04L 5/00; H04L 1/00

(52) U.S. Cl. CPC H04L 5/0057; H04L 1/0003

(57) ABSTRACT

Methods, systems, and devices for wireless communications are described that provide for configuration of one or more parameter tables that provide mapping between channel measurements and a channel quality indicator (CQI), one or more tables that provide mapping between a modulation and coding scheme (MCS) index and a modulation order and coding rate, or any combinations thereof. A base station may provide configuration information to a user equipment (UE) that indicates a table size for one or more CQI or MCS tables, and a number of bits that are to be transmitted in control information to indicate an index value for the CQI and/or MCS tables. Alternatively, an existing CQI or MCS table may have entries that are modified based on a modulation order that is supported by the UE, and the base station may provide configuration information that indicates the modified entries.

### FIELD OF TECHNOLOGY

The following relates to wireless communications, including transmission parameter signaling for higher order modulation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE and base station may communicate according to a modulation and coding scheme in which a modulation order and coding rate for communications is set based on channel conditions between the UE and base station. In some cases a UE may measure channel conditions and transmit a measurement report to the base station, which may set the modulation and coding scheme based at least in part on the channel conditions. Efficient techniques for signaling the channel conditions and modulation and coding scheme are thus desirable to help enhance network efficiency and reliability.

### SUMMARY

The described techniques relate to improved methods, systems, devices, and apparatuses that support transmission parameter signaling for higher order modulation. In accordance with various aspects, described techniques provide for configuration of one or more parameter tables that provide mapping between channel measurements and a channel quality indicator (CQI), one or more tables that provide mapping between a modulation and coding scheme (MCS) index and a modulation order and coding rate, or any combinations thereof. In some cases, a base station may provide configuration information to a user equipment (UE) that indicates a table size for one or more CQI or MCS tables, and a number of bits that are to be transmitted in control information to indicate an index value for the CQI and/or MCS tables. In some cases, one or more existing CQI or MCS tables may have one or more entries that are modified based on a modulation order that is supported by the UE, and the base station may provide configuration information that indicates the one or more modified entries.

A method for wireless communications at a user equipment (UE) is described. The method may include receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE, determining, based on a measurement of a reference signal from the base station, a first transmission parameter for communications between the base station and the UE and a first transmission parameter index value of the transmission parameter table entry that corresponds to the first transmission parameter, and transmitting, to the base station, control information that includes the first number of bits that indicate the first transmission parameter index value.

An apparatus for wireless communications at a UE is described. The apparatus may include a processor, memory coupled with the processor, and instructions stored in the memory. The instructions may be executable by the processor to cause the apparatus to receive, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE, determine, based on a measurement of a reference signal from the base station, a first transmission parameter for communications between the base station and the UE and a first transmission parameter index value of the transmission parameter table entry that corresponds to the first transmission parameter, and transmit, to the base station, control information that includes the first number of bits that indicate the first transmission parameter index value.

Another apparatus for wireless communications at a UE is described. The apparatus may include means for receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE, means for determining, based on a measurement of a reference signal from the base station, a first transmission parameter for communications between the base station and the UE and a first transmission parameter index value of the transmission parameter table entry that corresponds to the first transmission parameter, and means for transmitting, to the base station, control information that includes the first number of bits that indicate the first transmission parameter index value.

A non-transitory computer-readable medium storing code for wireless communications at a UE is described. The code may include instructions executable by a processor to receive, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE, determine, based on a measurement of a reference signal from the base station, a first transmission parameter for communications between the base station and the UE and a first transmission parameter index value of the transmission parameter table entry that corresponds to the first transmission parameter, and transmit, to the base station, control information that includes the first number of bits that indicate the first transmission parameter index value.

In some examples of the method, apparatuses, and non-transitory computer-readable medium described herein, the first number of bits is M bits and a value of M is indicated in the signaling to indicate the number of entries of a channel quality indicator (CQI) table. Some examples of the method, apparatuses, and non-transitory computer-readable medium described herein may further include operations, features, means, or instructions for receiving, from the base station, control information that includes a second number of bits that indicates a modulation and coding scheme (MCS) based on an entry in a MCS table that corresponds to an index value provided in the second number of bits, and where the second number of bits is N bits and a value of N is indicated in the signaling to indicate the number of entries of the MCS table.

In some examples of the method, apparatuses, and non-transitory computer-readable medium described herein, the signaling includes an indication of a subset of entries of the transmission parameter table that is usable for the communications between the base station and the UE, and where the determining the first transmission parameter index value is based on the subset of entries of the transmission parameter table. In some examples of the method, apparatuses, and non-transitory computer-readable medium described herein, the indication of the subset of entries of the transmission parameter table are provided in a bitmap that indicates available entries of the transmission parameter table. In some examples of the method, apparatuses, and non-transitory computer-readable medium described herein, the signaling indicates two or more different bitmaps that indicate different available entries of the transmission parameter table.

In some examples of the method, apparatuses, and non-transitory computer-readable medium described herein, a first bitmap of the two or more different bitmaps is selected when the communications between the base station use a first frequency range, and a second bitmap of the two or more different bitmaps is selected when the communications between the base station use a second frequency range. In some examples of the method, apparatuses, and non-transitory computer-readable medium described herein, the bitmap may be provided in radio resource control signaling, in a medium access control (MAC) control element, in downlink control information (DCI), or any combinations thereof, and indicates entries of one or more of a channel quality indicator (CQI) table or modulation and coding scheme (MCS) table.

In some examples of the method, apparatuses, and non-transitory computer-readable medium described herein, the transmission parameter table may be a channel quality indicator (CQI) table or modulation and coding scheme (MCS) table that includes entries associated with a set of multiple modulation orders including one or more of a quadrature phase shift keying (QPSK) modulation order, a 16 quadrature amplitude multiplexing (QAM) modulation order, a 16QAM modulation order, a 64QAM modulation order, a 256QAM modulation order, a 1024QAM modulation order, a 4096QAM modulation order, or any combinations thereof.

A method for wireless communications at a UE is described. The method may include receiving, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE, determining, based on a measurement of a reference signal from the base station, a first transmission parameter for communications between the base station and the UE and a first transmission parameter index value of the modified transmission parameter table entry that corresponds to the first transmission parameter, and transmitting, to the base station, control information that includes the first transmission parameter index value.

An apparatus for wireless communications at a UE is described. The apparatus may include a processor, memory coupled with the processor, and instructions stored in the memory. The instructions may be executable by the processor to cause the apparatus to receive, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE, determine, based on a measurement of a reference signal from the base station, a first transmission parameter for communications between the base station and the UE and a first transmission parameter index value of the modified transmission parameter table entry that corresponds to the first transmission parameter, and transmit, to the base station, control information that includes the first transmission parameter index value.

Another apparatus for wireless communications at a UE is described. The apparatus may include means for receiving, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE, means for determining, based on a measurement of a reference signal from the base station, a first transmission parameter for communications between the base station and the UE and a first transmission parameter index value of the modified transmission parameter table entry that corresponds to the first transmission parameter, and means for transmitting, to the base station, control information that includes the first transmission parameter index value.

A non-transitory computer-readable medium storing code for wireless communications at a UE is described. The code may include instructions executable by a processor to receive, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE, determine, based on a measurement of a reference signal from the base station, a first transmission parameter for communications between the base station and the UE and a first transmission parameter index value of the modified transmission parameter table entry that corresponds to the first transmission parameter, and transmit, to the base station, control information that includes the first transmission parameter index value.

In some examples of the method, apparatuses, and non-transitory computer-readable medium described herein, a predetermined number entries of the first modulation order are replaced with entries of the second modulation order, and where the second modulation order are a higher modulation order than the first modulation order. In some examples of the method, apparatuses, and non-transitory computer-readable medium described herein, the predetermined number of entries of the first modulation order are a subset of entries of the first modulation order. In some examples of the method, apparatuses, and non-transitory computer-readable medium described herein, the subset of entries of the first modulation order each have a lower spectral efficiency than one or more entries of the first modulation order that are outside of the subset of entries. In some examples of the method, apparatuses, and non-transitory computer-readable medium described herein, the signaling indicates a number of entries for each of two or more modulation orders that are to be replaced. In some examples of the method, apparatuses, and non-transitory computer-readable medium described herein, the set of multiple entries that are to be modified are provided for a channel quality indicator (CQI) table, and where a corresponding set of multiple entries for a modulation and coding scheme (MCS) table are also modified based on the set of multiple entries for the channel quality information (CQI) table.

A method for wireless communications at a base station is described. The method may include transmitting, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order, receiving, from the UE, control information that indicates the transmission parameter index value, and determining, based on a transmission parameter indicated by the transmission parameter index value and a modulation order associated with the transmission parameter index value, a first transmission parameter for communications between the base station and the UE.

An apparatus for wireless communications at a base station is described. The apparatus may include a processor, memory coupled with the processor, and instructions stored in the memory. The instructions may be executable by the processor to cause the apparatus to transmit, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order, receive, from the UE, control information that indicates the transmission parameter index value, and determine, based on a transmission parameter indicated by the transmission parameter index value and a modulation order associated with the transmission parameter index value, a first transmission parameter for communications between the base station and the UE.

Another apparatus for wireless communications at a base station is described. The apparatus may include means for transmitting, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order, means for receiving, from the UE, control information that indicates the transmission parameter index value, and means for determining, based on a transmission parameter indicated by the transmission parameter index value and a modulation order associated with the transmission parameter index value, a first transmission parameter for communications between the base station and the UE.

A non-transitory computer-readable medium storing code for wireless communications at a base station is described. The code may include instructions executable by a processor to transmit, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order, receive, from the UE, control information that indicates the transmission parameter index value, and determine, based on a transmission parameter indicated by the transmission parameter index value and a modulation order associated with the transmission parameter index value, a first transmission parameter for communications between the base station and the UE.

In some examples of the method, apparatuses, and non-transitory computer-readable medium described herein, the first number of bits is based on one or more of a size of the transmission parameter table or a number of entries of the transmission parameter table that are configured for the communications between the base station and the UE. In some examples of the method, apparatuses, and non-transitory computer-readable medium described herein, the first number of bits is M bits and a value of M is indicated in the configuration information to indicate the number of entries of a channel quality indicator (CQI) table, and wherein a second number of bits is N bits used to indicate an entry in a modulation and coding scheme (MCS) table, and a value of N is further indicated in the configuration information.

In some examples of the method, apparatuses, and non-transitory computer-readable medium described herein, the signaling includes an indication of a subset of entries of the transmission parameter table that are usable for the communications between the base station and the UE, and where the transmission parameter index value is based on the subset of entries of the transmission parameter table. In some examples of the method, apparatuses, and non-transitory computer-readable medium described herein, the indication of the subset of entries of the transmission parameter table is provided in a bitmap that indicates available entries of the transmission parameter table. In some examples of the method, apparatuses, and non-transitory computer-readable medium described herein, a first bitmap of two or more different bitmaps may be selected when the communications between the base station use a first frequency range, and a second bitmap of the two or more different bitmaps may be selected when the communications between the base station use a second frequency range.

In some examples of the method, apparatuses, and non-transitory computer-readable medium described herein, the one or more modifications to the transmission parameter table include a predetermined number of entries of the first modulation order is replaced with entries of the second modulation order, and where the second modulation order is a higher modulation order than the first modulation order. In some examples of the method, apparatuses, and non-transitory computer-readable medium described herein, the predetermined number of entries of the first modulation order is a subset of entries of the first modulation order. In some examples of the method, apparatuses, and non-transitory computer-readable medium described herein, the subset of entries of the first modulation order each have a lower spectral efficiency than one or more entries of the first modulation order that are outside of the subset of entries.

### BRIEF DESCRIPTION OF THE DRAWINGS

FIG. 1 illustrates an example of a wireless communications system that supports transmission parameter signaling for higher order modulation in accordance with aspects of the present disclosure.

FIG. 2 illustrates an example of a wireless communications system that supports transmission parameter signaling for higher order modulation in accordance with aspects of the present disclosure.

FIGS. 3 and 4 illustrate examples of process flows that support transmission parameter signaling for higher order modulation in accordance with aspects of the present disclosure.

FIGS. 5 and 6 show block diagrams of devices that support transmission parameter signaling for higher order modulation in accordance with aspects of the present disclosure.

FIG. 7 shows a block diagram of a communications manager that supports transmission parameter signaling for higher order modulation in accordance with aspects of the present disclosure.

FIG. 8 shows a diagram of a system including a device that supports transmission parameter signaling for higher order modulation in accordance with aspects of the present disclosure.

FIGS. 9 and 10 show block diagrams of devices that support transmission parameter signaling for higher order modulation in accordance with aspects of the present disclosure.

FIG. 11 shows a block diagram of a communications manager that supports transmission parameter signaling for higher order modulation in accordance with aspects of the present disclosure.

FIG. 12 shows a diagram of a system including a device that supports transmission parameter signaling for higher order modulation in accordance with aspects of the present disclosure.

FIGS. 13 through 16 show flowcharts illustrating methods that support transmission parameter signaling for higher order modulation in accordance with aspects of the present disclosure.

### DETAILED DESCRIPTION

In some wireless communications systems, multiple different modulation orders may be available for communications between a user equipment (UE) and a base station. A UE and base station may communicate according to a modulation and coding scheme in which a modulation order and coding rate for communications is set based on channel conditions between the UE and base station. In some cases a UE may measure channel conditions and transmit a measurement report to the base station, which may set the modulation and coding scheme based at least in part on the channel conditions. For example, a UE may measure one or more reference signals transmitted by a base station (e.g., a channel state information reference signal (CSI-RS)), and transmit a measurement report to the base station that indicates measured channel conditions. The measurement report may include, in some cases, channel quality indicator (CQI) that is an index value to an established CQI table that maps CQI index values to different combinations of modulation orders, code rates, and spectral efficiency. Based on the measurement report, the base station may allocate resources to a UE for communications using a modulation order and code rate that is indicated as an index value into an MCS table that maps MCS index values different combinations of modulation orders, code rates, and spectral efficiency.

In some wireless communications systems, UEs may be deployed that have relatively advanced receiver designs that are capable of supporting relatively high modulation orders. For example, some systems may support modulation orders ranging from quadrature phase shift keying (QPSK) through 64 quadrature amplitude multiplexing (QAM), other more advanced systems may support modulation orders up to 1024-QAM, and in some even more advanced systems modulation orders of up to 4096-QAM. In systems supporting higher modulation orders, signaling of CQI and MCS values may provide information for transmission parameters for a relatively large range of modulation orders. However, simply increasing table sizes for various different combinations of supported modulation orders may result in increased overhead, which is undesirable. In some systems, modified tables have been proposed in which various lower modulation order entries may be removed to allow for indication of higher modulation order entries without increasing a number of bits used to signal the index value into the particular table, where signaling of the index values uses a fixed number of bits in uplink control information (UCI) and downlink control information (DCI). However, such techniques decrease options for different combinations of modulation orders and code rates, which may reduce overall network efficiency.

In accordance with various aspects as discussed herein, described techniques provide for configuration of one or more parameter tables with different numbers of table entries that provide mapping between channel measurements and a CQI, that provide mapping between a MCS index and a modulation order and coding rate, or any combinations thereof. In some cases, a base station may provide configuration information to a UE that indicates a table size for one or more CQI or MCS tables, and a number of bits that are to be transmitted in control information to indicate an index value for the CQI and/or MCS tables (e.g., an MCS indication field size, a CQI indication field size, or any combinations thereof). In some cases, one or more existing CQI or MCS tables may have one or more entries that are modified based on a modulation order that is supported by the UE, and the base station may provide configuration information that indicates the one or more modified entries. Additionally or alternatively, a relatively large CQI or MCS table may be used for indicating CQI or MCS values, and a bitmap may be provided to indicate which table entries from the CQI or MCS tables are to be used for communications, such that a number of available table entries corresponds to a size of an indication field for indicating a table index value. In such cases, a base station may select available combinations of modulation orders and code rates based on channel conditions and provide the bitmap (e.g., in configuration information provided in radio resource control (RRC) signaling or in a medium access control (MAC) control element (CE)) that indicates the selected combinations. Thus, control information overhead associated with CQI and MCS indications may not need to be increased, while allowing relatively good resolution for modulation order and code rate combinations that may provide for enhanced communications efficiency.

Aspects of the disclosure are initially described in the context of wireless communications systems. Aspects of the disclosure are further illustrated by and described with reference to process flows, apparatus diagrams, system diagrams, and flowcharts that relate to transmission parameter signaling for higher order modulation.

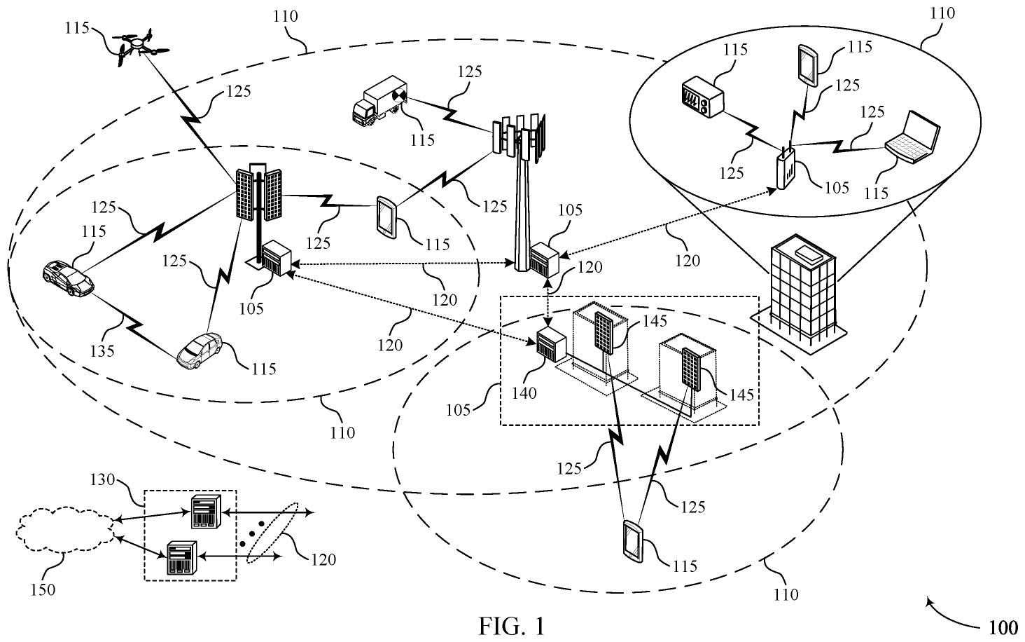

FIG. 1 illustrates an example of a wireless communications system 100 that supports transmission parameter signaling for higher order modulation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some cases, one or more UEs 115 may be capable of supporting relatively high modulation orders, such as 1024-QAM or 4096-QAM. In some cases, to support signaling of transmission parameters for higher modulation orders, a base station 105 may configure one or more tables with different numbers of table entries that provide mapping between a CQI or MCS index and a modulation order and coding rate. In some cases, a base station 105 may provide configuration information to a UE 115 that indicates a table size for one or more CQI or MCS tables, and a number of bits that are to be transmitted in control information to indicate an index value for the CQI and/or MCS tables (e.g., an MCS indication field size, a CQI indication field size, or any combinations thereof). Additionally or alternatively, one or more modified tables may be configured by a base station 105 and indicated to a UE 115 for supporting higher modulation orders.

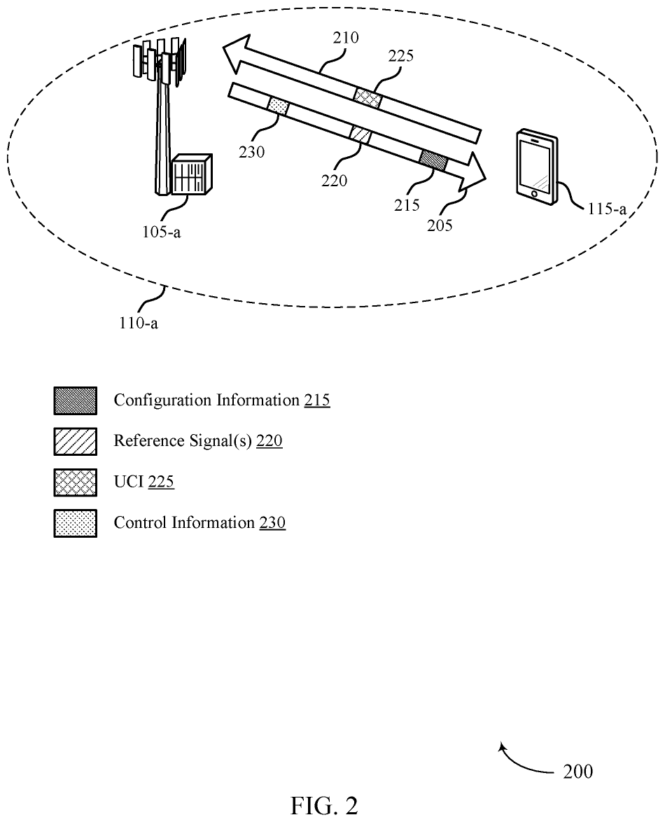

FIG. 2 illustrates an example of a wireless communications system 200 that supports transmission parameter signaling for higher order modulation in accordance with aspects of the present disclosure. In some examples, the wireless communications system 200 may implement aspects of wireless communications system 100. Wireless communications system 200 may include UE 115-a that may be an example of a UE 115 as described with respect to FIG. 1, and base station 105-a that may be an example of a base station 105 as described with respect to FIG. 1. The base station 105-a may serve one or more UEs 115, including UE 115-a, within coverage area 110-a. The base station 105-a and UE 115-a in this example may exchange downlink and uplink communications using downlink carrier 205 and uplink carrier 210 (which may be a same carrier or different carriers).

As discussed herein, in some cases, UE 115-a may be capable of supporting relatively high modulation orders, such as 1024-QAM or 4096-QAM. In some cases, to support signaling of transmission parameters for higher modulation orders, base station 105-a may configure one or more CQI or MCS tables that provide mapping between a CQI or MCS index and a modulation order, coding rate, and spectral efficiency. For example, the base station 105-a may provide configuration information 215 to UE 115-a (e.g., in RRC signaling) that indicates one or more CQI or MCS tables or modifications to one or more tables. Based on the configuration information 215, the UE 115-a may measure one or more reference signals 220 transmitted by the base station 105-a, and determine a CQI from the configured CQI table that is to be reported to the base station 105-a in a measurement report that is transmitted in UCI 225. Based on the reported CQI, the base station 105-a may determine a MCS for communications with the UE 115-a, and may transmit control information 230 (e.g., DCI) that provides an MCS index for the configured MCS table.

In some cases, the UE 115-a may support 4096-QAM, and the configuration information may indicate that a 4096-QAM table is to be used for indicating CQI and MCS index values, where a number of bits that are to be transmitted in control information to indicate the index values is based on a size of the configured table. In some cases, one or more higher modulation order MCS and CQI tables may be specified and one of such tables selected by the base station 105-a and indicated to the UE 115-a in the configuration information. In some cases, one or more of a CQI indication field or MCS indication field may include a number of bits that is based on a size of the configured tables. For example, a legacy MCS indication field size is 5 bits and CQI indication field size is 4 bits for many wireless deployments. In accordance with aspects in which larger MCS or CQI tables are configured, the MCS field indication size may be increased to N bits (e.g., N>5) and the CQI field indication size may be increased to M bits (e.g., M>4), with the values of N and M configured via the configuration information 215. Thus, in such cases, the UE 115-a may be configured to use additional control information 215 overhead when higher modulation orders may be used, and may be configured to use less control information 215 overhead when lower modulation orders are to be used. In some cases, the base station 105-a may determine which MCS and CQI tables are to be used based on various factors, such as channel conditions, expected traffic volume, a number of UEs that are currently being served by the base station 105-a, a type of data traffic, or any combinations thereof.

In some cases, in order to reduce control information 215 overhead and provide signaling for higher modulation orders, one or more tables may be modified to replace lower modulation order entries with higher modulation order entries. Additionally or alternatively, a relatively large table may be provided (e.g., defined in a wireless communications protocol specification, such as a 3GPP specification) and the base station 105-a may down-select entries to be used for communications, and the configuration information 215 may indicate the down-selected entries (e.g., using a bitmap in RRC or MAC-CE).

In some cases, a CQI table may be defined that is an M-bit table with 2^{M} entries, and M>4, thus providing a CQI table that may contain at least 32-entries. Such expanded tables may provide additional combinations for low, medium, and high modulation order cases, which may allow communications to use modulation orders and coding rates that are more optimal to channel conditions and thus enhance network efficiency. Such techniques also increase the signaling size, such as CQI feedback in CSI-RS procedures. In some cases, in order to provide reduced control information 230 overhead, the base station 105-a may include a bitmap or other information in the configuration information 215 that down-selects available table entries (e.g., using a bitmap in RRC or a MAC-CE to down-select the table entries to 16 for CQI and to 32 for MCS).

In other cases, the base station 105-a and UE 115-a may utilize existing CQI and MCS tables, remove L entries from one or more lower modulation orders, and add L entries for one or more higher modulation orders. For example, the base station 105-a may use CQI-table mapping to each of multiple different tables for all modulation orders (e.g., remove L entries from certain K-QAM entries with multiple entries). In other cases, the base station 105-a may use CQI-table mapping to only a subset of available tables (e.g., for a high spectral efficiency (SE) table) to remove lower modulation order entries and add higher modulation order entries (e.g., remove L explicit CQI entries (from CQI indices 0-15) from a 256-QAM CQI table and add L new entries for higher modulation order(s) such as 1024-QAM and/or 4096-QAM).

In one specific example, three CQI tables may be defined to include a 64-QAM table (Table 1 below), a 256-QAM (high SE) table (Table 2 below), and a 64-QAM Low SE table (Table 3 below). In each of the tables, a CQI index (having a four-bit index value corresponding to 16 table entries) is associated with a particular modulation order, supported code rate, and spectral efficiency.

TABLE 1
64 QAM CQI Table

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 2
256 QAM (High SE) CQI Table

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 3
64 QAM (Low SE) CQI Table

| CQI index | modulation | code rate × 1024 | efficiency |
|---|---|---|---|
| 0 | out of range | | |
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

In some cases, entries from one or multiple of the available tables may be replaced with different entries for higher order modulation. Several examples are provided for modifications to Table 2, with the understanding that techniques described herein may be applied to any CQI or MCS table, or other transmission parameter table.

In a first example, Table 2 may be modified to replace multiple lower modulation order entries with a corresponding number of higher modulation order entries (e.g., QPSK and 64-QAM entries may be removed from Table 2 and 1024-QAM and 4096-QAM entries may be added). In some examples, illustrated in Tables 2-1 through 2-6 below, two entries are removed for 1024-QAM and two entries are removed for 4096-QAM. In a first example, illustrated in Table 2-1, entries 5, 7, 10, and 11 are removed from Table 2 and entries 16, 17, 18, and 19 are added. In a second example, illustrated in Table 2-2, entries 1, 2, 10, and 11 are removed from Table 2 and entries 16, 17, 18, and 19 are added. In a third example, illustrated in Table 2-3, entries 5, 7, 14, and 15 are removed from Table 2 and entries 16, 17, 18, and 19 are added. In a fourth example, illustrated in Table 2-4, entries 5, 7, 12, and 13 are removed from Table 2 and entries 16, 17, 18, and 19 are added. The index values of the table are then updated in accordance with the removed/added entries, so that a reported index value corresponds to the re-ordered table.

TABLE 2-1
256 QAM (High SE) CQI Table
(higher SE entries replaced for 4096QAM)

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |
| 16 | 1024QAM | 853 | 8.3301 |
| 17 | 1024QAM | 948 | 9.2578 |
| 18 | 4096QAM | 853 | 9.9961 |
| 19 | 4096QAM | 948 | 11.1094 |

TABLE 2-2
256 QAM (High SE) CQI Table
(lower SE entries replaced for 4096QAM)

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |
| 16 | 1024QAM | 853 | 8.3301 |
| 17 | 1024QAM | 948 | 9.2578 |
| 18 | 4096QAM | 853 | 9.9961 |
| 19 | 4096QAM | 948 | 11.1094 |

TABLE 2-3
256 QAM (High SE) CQI Table
(higher SE 256QAM entries replaced for 4096QAM)

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |
| 16 | 1024QAM | 853 | 8.3301 |
| 17 | 1024QAM | 948 | 9.2578 |
| 18 | 4096QAM | 853 | 9.9961 |
| 19 | 4096QAM | 948 | 11.1094 |

TABLE 2-4
256 QAM (High SE) CQI Table
(higher SE 256QAM entries replaced for 4096QAM)

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |
| 16 | 1024QAM | 853 | 8.3301 |
| 17 | 1024QAM | 948 | 9.2578 |
| 18 | 4096QAM | 853 | 9.9961 |
| 19 | 4096QAM | 948 | 11.1094 |

In other examples, entries from multiple different modulation orders may be removed based on a pattern or formula. For example, as illustrated in Table 2-5 below, a CQI table may be modified to remove L₁ entries from QPSK, L₂ entries from 16QAM, L₃ entries from 64QAM, and L₄ entries from 256QAM, where L₁+L₂+L₃+L₄=L or a total number of table entries that are replaced (i.e., the required L entries that are replaced). In some cases, the Lᵢ entries may be from low SE cases or high SE cases (as illustrated in Table 2-5) within a modulation order. In some cases, the number of Lᵢ (for all i) may be a function of a frequency range in which the UE is operating (e.g., FR1, FR2, etc.), may be a function a phase tracking reference signal (PTRS) configuration (e.g., a low or high density PTRS configuration), or any combinations thereof. In the example of Table 2-5, we need L=2 (remove 2 entries), L_1=0, L_2=0, L_3=1, L_4=1

TABLE 2-5
256 QAM (High SE) CQI Table
(Lᵢ entries removed from modulation order i and replaced)

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |
| 16 | 1024QAM | 853 | 8.3301 |
| 17 | 1024QAM | 948 | 9.2578 |
| 18 | 4096QAM | 853 | 9.9961 |
| 19 | 4096QAM | 948 | 11.1094 |

In some cases, the base station 105-a may provide in indication of a larger table that is to be used, and may also provide a bitmap or other indication of down-selected entries from the table, to enable flexible and robust tables that provide transmission parameters that are suited for particular channel conditions at the UE 115-a. For example, the base station 105-a may designate a relatively large table (e.g., M=5 or more bits for a table with 32 or 64 entries). In such cases, each modulation order will have multiple entries. The base station 105-a may then (e.g., using RRC or a MAC-CE) down-select the entries to 16 entries for CQI and 32 entries for MCS using a bitmap of size 2_{M} for CQI and 2_{N} for MCS. In some cases, multiple bitmaps may be defined and used based on conditions at the UE 115-a, such as two different bitmaps based on the frequency range (FR) of communications (e.g., FR1 or FR2). Thus, the UE 115-a may select the appropriate table entries for signaled table index values based on the bitmap corresponding to the FR of communications.

While these examples are discussed with reference to CQI tables, such techniques may be applied to MCS tables as well. For example, entry replacement for MCS tables may be performed based on the CQI table entries that are removed and added (e.g., entries removed from a CQI table have corresponding entries removed from the MCS table). Tables 4-1 and 4-2 show MCS index tables that are updated with removed/added entries that correspond to the changes from Tables 2-1 and 2-2, for example, which have entries removed and added in accordance with CQI Tables 2-1 and 2-2.

TABLE 4-1
256 QAM (High SE) MCS Table

| MCS | Modulation | Target | |
|---|---|---|---|
| Index | Order | code Rate | Spectral |
| I_{MCS} | Qₘ | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |
| 28 | 2 | reserved | |
| 29 | 4 | reserved | |
| 30 | 6 | reserved | |
| 31 | 8 | reserved | |
| 32 | 10 | 853 | 8.3301 |
| 33 | 10 | 948 | 9.2578 |
| 34 | 12 | 853 | 9.9961 |
| 35 | 12 | 948 | 11.1094 |

TABLE 4-2
256 QAM (High SE) MCS Table

| MCS | Modulation | Target | |
|---|---|---|---|
| Index | Order | code Rate | Spectral |
| I_{MCS} | Qₘ | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |
| 28 | 2 | reserved | |
| 29 | 4 | reserved | |
| 30 | 6 | reserved | |
| 31 | 8 | reserved | |
| 32 | 10 | 853 | 8.3301 |
| 33 | 10 | 948 | 9.2578 |
| 34 | 12 | 853 | 9.9961 |
| 35 | 12 | 948 | 11.1094 |

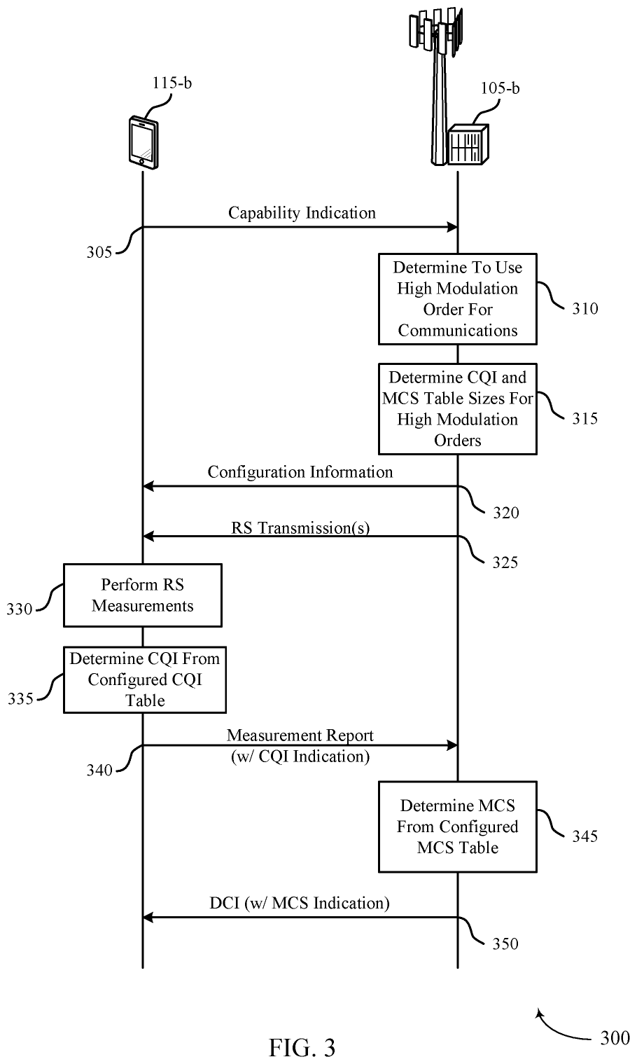

FIG. 3 illustrates an example of a process flow 300 that supports transmission parameter signaling for higher order modulation in accordance with aspects of the present disclosure. In some examples, the process flow 300 may implement aspects of a wireless communications systems 100 or 200, as described with reference to FIGS. 1 and 2. The process flow 300 may include a UE 115-b and a base station 105-b which may be examples of the corresponding devices described herein. Alternative examples of the following may be implemented where some processes are performed in a different order than described or not performed at all. In some implementations, processes may include additional features not mentioned below, or further processes may be added.

At 305, the UE 115-b may transmit a capability indication to the base station 105-b. In some cases, the capability indication may indicate that the UE 115-b has a capability to support higher modulation orders, such as 1024-QAM and 4096-QAM. In some cases, the capability indication may be provided along with other UE 115-b capabilities in RRC signaling, as part of a connection establishment between the UE 115-b and base station 105-b.

At 310, the base station 105-b may determine to use high modulation orders for communications with the UE 115-b. For example, the base station 105-b may determine that the UE 115-b has a capability to communication using high modulation orders (e.g., 4096-QAM), that channel conditions for the UE 115-b are likely to support high modulation orders (e.g., based on channel measurements provided by the UE 115-b or a location of the UE 115-b), that traffic conditions would benefit from high modulation order communications (e.g., an amount of traffic that is expected for the UE 115-b), or any combinations thereof.

At 315, the base station 105-b may determine CQI and MCS table sizes for high modulation orders. In some cases, the base station 105-a may determine to use a CQI table that is indexed by an N-bit index value, and an MCS table that is indexed by an M-bit index value, where N and M provide for more table entries than are present in parameter tables associated with lower modulation orders (e.g., 256-QAM or lower modulation orders). In some cases, multiple different sizes are available for CQI and MCS tables, based on a highest supported modulation order (e.g., one or more tables for 1024-QAM, and one or more other tables for 4096-QAM), and the table sizes are determined based on the highest modulation order that is expected to be used for communications with the UE 115-b.

At 320, the base station 105-b may transmit configuration information, which may be received at the UE 115-b. In some cases, the configuration information may include an indication that higher modulation orders are configured for communications between the UE 115-b and the base station 105-b. In some cases, the configuration information may indicate table sizes for transmission parameter tables, such as CQI and MCS table sizes, and a number of bits that are to be used for signaling of table index values for the configured table sizes.

At 325, the base station 105-b may transmit one or more reference signals (e.g., one or more CSI-RSs). At 330, the UE 115-b may receive the one or more reference signals and perform reference signal measurements. For example, the UE 115-b may perform CSI-RS measurements to determine one or more metrics associated with a channel quality between the base station 105-b and the UE 115-b (e.g., reference signal received power (RSRP), reference signal received quality (RSRQ), signal to noise ratio (SNR), signal to interference and noise ratio (SINR), signal-to-noise plus distortion ratio (SNDR), and the like).

At block 335, the UE 115-b may determine a CQI index value to be reported from a configured CQI table. In some cases, the CQI index value may be determined based on a highest modulation order, code rate, and spectral efficiency that the UE 115-b can support based on the measurements of the reference signal transmissions from the base station 105-b and a mapping between the measurements and the CQI index value. At 340, the UE 115-b may transmit a measurement report to the base station 105-b, which may include a CQI indication that corresponds to the determined CQI index value.

At 345, the base station 105-b may determine a MCS from the configured MCS table for communications with the UE 115-b. In some cases, the MCS may be determined based on the indicated CQI from the UE 115-b, an amount of data to be transmitted to the UE 115-b, other traffic for other UEs, a frequency band for communications with the UE 115-b, power constraints at the UE 115-b or base station 105-b, or any combinations thereof. At 350, the base station 105-b may transmit downlink control information (DCI) to the UE 115-b with an indication of the determined MCS. The UE 115-b and base station 105-b may then exchange communications based on resource allocations and the MCS indication provided in the DCI.

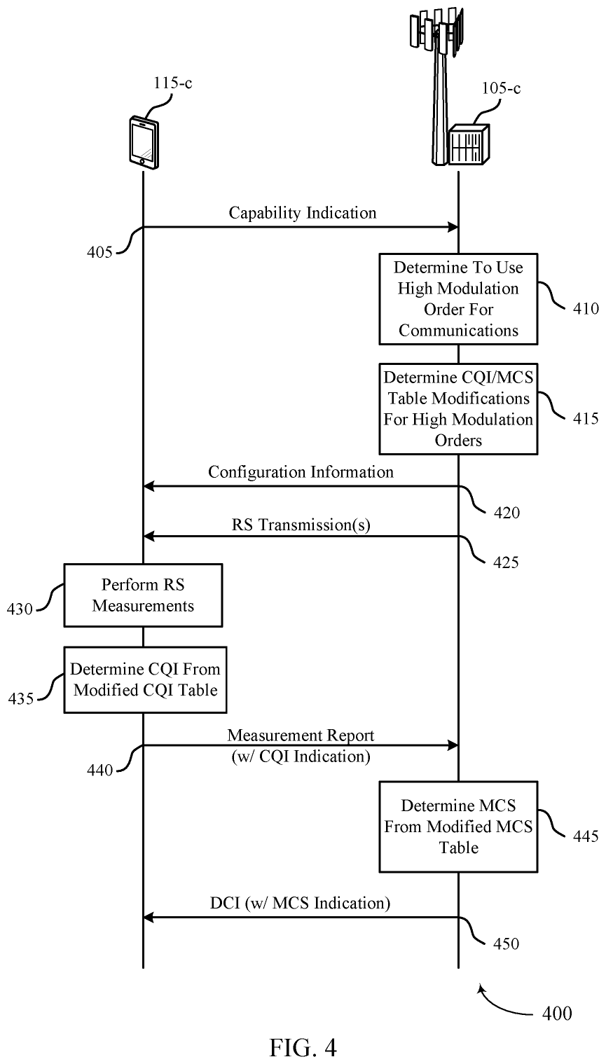

FIG. 4 illustrates an example of a process flow 400 that supports transmission parameter signaling for higher order modulation in accordance with aspects of the present disclosure. In some examples, the process flow 400 may implement aspects of a wireless communications systems 100 or 200, as described with reference to FIGS. 1 and 2. The process flow 400 may include a UE 115-c and a base station 105-c which may be examples of the corresponding devices described herein. Alternative examples of the following may be implemented where some processes are performed in a different order than described or not performed at all. In some implementations, processes may include additional features not mentioned below, or further processes may be added.

At 405, the UE 115-c may transmit a capability indication to the base station 105-c. In some cases, the capability indication may indicate that the UE 115-c has a capability to support higher modulation orders, such as 1024-QAM and 4096-QAM. In some cases, the capability indication may be provided along with other UE 115-c capabilities in RRC signaling, as part of a connection establishment between the UE 115-c and base station 105-c.

At 410, the base station 105-c may determine to use high modulation orders for communications with the UE 115-c. For example, the base station 105-c may determine that the UE 115-c has a capability to communication using high modulation orders (e.g., 4096-QAM), that channel conditions for the UE 115-c are likely to support high modulation orders (e.g., based on channel measurements provided by the UE 115-c or a location of the UE 115-c), that traffic conditions would benefit from high modulation order communications (e.g., an amount of traffic that is expected for the UE 115-c), or any combinations thereof.

At 415, the base station 105-c may determine CQI and MCS table modifications for high modulation orders. In some cases, the base station 105-a may determine to use a modified CQI table and/or modified MCS table that has one or more default entries associated with lower modulation orders removed and a corresponding number of additional entries associated with higher modulation orders. In some cases, a relatively large table may be selected based on a high modulation order for the UE 115-b, and entries for communications with the UE 115-b may be down-selected in order to provide index values to the remaining table entries that can be signaled by fewer bits than would be required if the table entries were not down-selected. In some cases, the down-selection may provide transmission parameters that are expected to be suitable for communications with the UE 115-b based on expected modulation orders to be used with the UE 115-b (e.g., code rates for one or more modulation orders may be selected to provide several suitable options for communications using one or more modulation orders, which may help to enhance efficiency and reliability of wireless communications). In some cases, a bitmap may be generated to indicate the table modifications. In some cases, two or more bitmaps may be generated that are associated with particular communications (e.g., a first bitmap may be generated for FR1 communications that corresponds to more higher modulation order entries, and a second bitmap may be generated for FR2 communications that corresponds to fewer higher modulation order entries).

At 420, the base station 105-c may transmit configuration information, which may be received at the UE 115-c. In some cases, the configuration information may include an indication higher modulation orders are configured for communications between the UE 115-c and the base station 105-c. In some cases, the configuration information may indicate one or more selected CQI/MCS tables and modifications to the selected table(s) (e.g., a number L of entries that are to be removed/added to a table, a bitmap that indicates table entries that are available to be selected at the UE 115-c (e.g., for CQI indication) or at the base station (e.g., for MCS indication), or combinations thereof).

At 425, the base station 105-c may transmit one or more reference signals (e.g., one or more CSI-RSs). At 430, the UE 115-c may receive the one or more reference signals and perform reference signal measurements. For example, the UE 115-c may perform CSI-RS measurements to determine one or more metrics associated with a channel quality between the base station 105-c and the UE 115-c (e.g., reference signal received power (RSRP), reference signal received quality (RSRQ), signal to noise ratio (SNR), signal to interference and noise ratio (SINR), signal-to-noise plus distortion ratio (SNDR), and the like).

At block 435, the UE 115-c may determine a CQI index value to be reported from the modified CQI table. In some cases, the CQI index value may be determined based on a highest modulation order, code rate, and spectral efficiency that the UE 115-c can support based on the measurements of the reference signal transmissions from the base station 105-c and a mapping between the measurements and the modified CQI table. At 440, the UE 115-c may transmit a measurement report to the base station 105-c, which may include a CQI indication that corresponds to the determined CQI index value.

At 445, the base station 105-c may determine a MCS from the modified MCS table for communications with the UE 115-c. In some cases, the MCS may be determined based on the indicated CQI from the UE 115-c, an amount of data to be transmitted to the UE 115-c, other traffic for other UEs, a frequency band for communications with the UE 115-c, power constraints at the UE 115-c or base station 105-c, or any combinations thereof. At 450, the base station 105-c may transmit DCI to the UE 115-c with an indication of the determined MCS. The UE 115-c and base station 105-c may then exchange communications based on resource allocations and the MCS indication provided in the DCI.

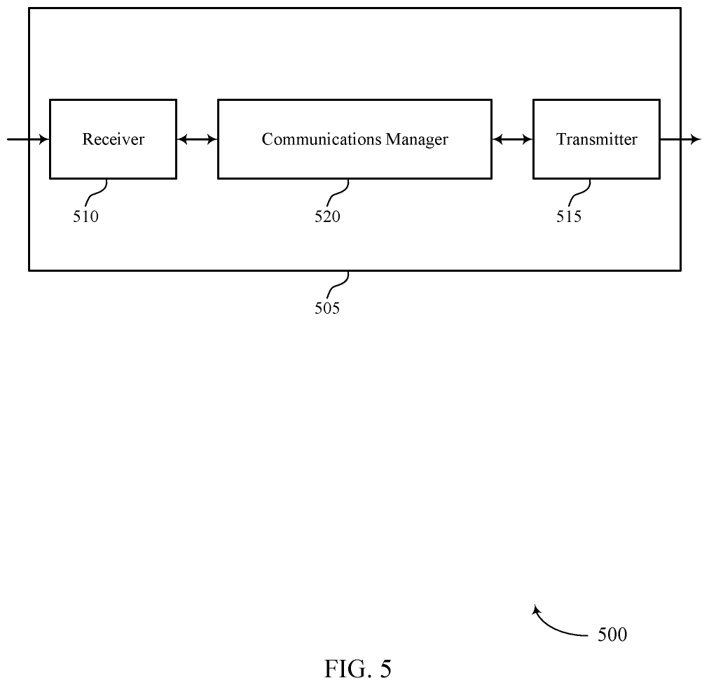

FIG. 5 shows a block diagram 500 of a device 505 that supports transmission parameter signaling for higher order modulation in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to transmission parameter signaling for higher order modulation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to transmission parameter signaling for higher order modulation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of transmission parameter signaling for higher order modulation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE. The communications manager 520 may be configured as or otherwise support a means for determining, based on a measurement of a reference signal from the base station, a first transmission parameter for communications between the base station and the UE and a first transmission parameter index value of the transmission parameter table entry that corresponds to the first transmission parameter. The communications manager 520 may be configured as or otherwise support a means for transmitting, to the base station, control information that includes the first number of bits that indicate the first transmission parameter index value.

Additionally or alternatively, the communications manager 520 may support wireless communications at a UE in accordance with examples as disclosed herein. For example, the communications manager 520 may be configured as or otherwise support a means for receiving, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE. The communications manager 520 may be configured as or otherwise support a means for determining, based on a measurement of a reference signal from the base station, a first transmission parameter for communications between the base station and the UE and a first transmission parameter index value of the modified transmission parameter table entry that corresponds to the first transmission parameter. The communications manager 520 may be configured as or otherwise support a means for transmitting, to the base station, control information that includes the first transmission parameter index value.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for transmission parameter signaling based on configured tables (e.g., CQI/MCS tables), which may allow for enhanced communications efficiency, reduced power consumption, more efficient utilization of communication resources, and enhanced reliability.

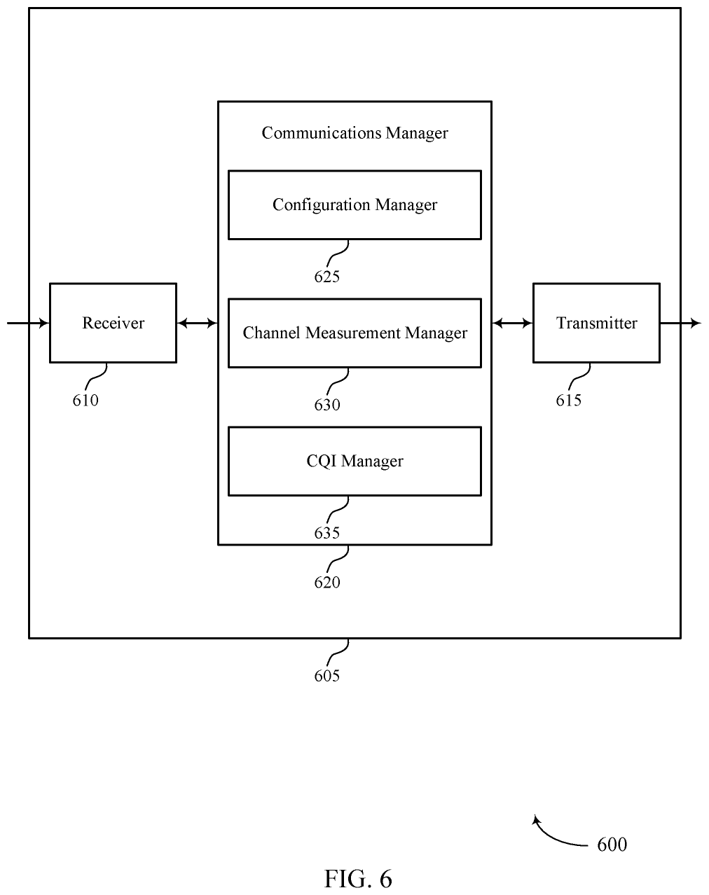

FIG. 6 shows a block diagram 600 of a device 605 that supports transmission parameter signaling for higher order modulation in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to transmission parameter signaling for higher order modulation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to transmission parameter signaling for higher order modulation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of transmission parameter signaling for higher order modulation as described herein. For example, the communications manager 620 may include a configuration manager 625, a channel measurement manager 630, a CQI manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The configuration manager 625 may be configured as or otherwise support a means for receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE. The channel measurement manager 630 may be configured as or otherwise support a means for determining, based on a measurement of a reference signal from the base station, a first transmission parameter for communications between the base station and the UE and a first transmission parameter index value of the transmission parameter table entry that corresponds to the first transmission parameter. The CQI manager 635 may be configured as or otherwise support a means for transmitting, to the base station, control information that includes the first number of bits that indicate the first transmission parameter index value.

Additionally or alternatively, the communications manager 620 may support wireless communications at a UE in accordance with examples as disclosed herein. The configuration manager 625 may be configured as or otherwise support a means for receiving, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE. The channel measurement manager 630 may be configured as or otherwise support a means for determining, based on a measurement of a reference signal from the base station, a first transmission parameter for communications between the base station and the UE and a first transmission parameter index value of the modified transmission parameter table entry that corresponds to the first transmission parameter. The CQI manager 635 may be configured as or otherwise support a means for transmitting, to the base station, control information that includes the first transmission parameter index value.

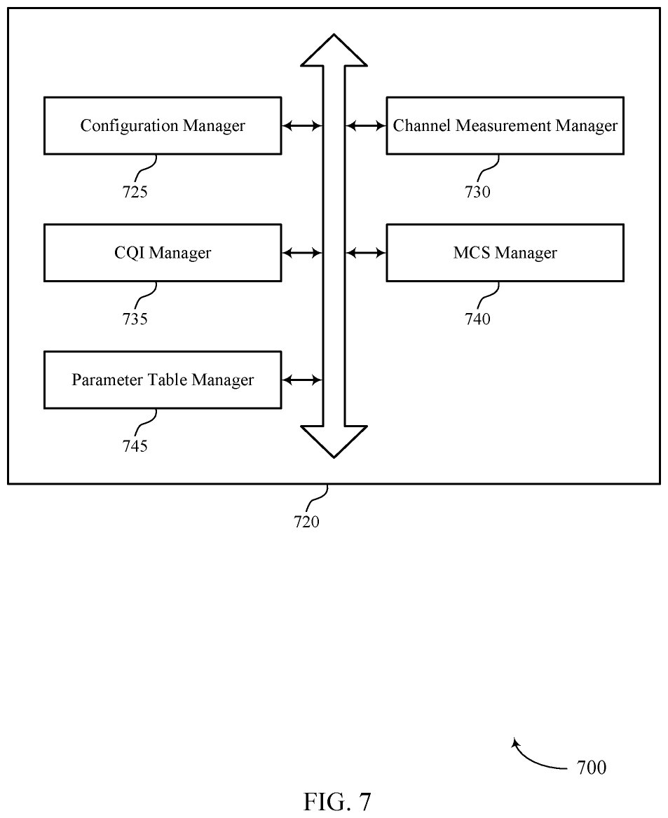

FIG. 7 shows a block diagram 700 of a communications manager 720 that supports transmission parameter signaling for higher order modulation in accordance with aspects of the present disclosure. The communications manager 720 may be an example of aspects of a communications manager 520, a communications manager 620, or both, as described herein. The communications manager 720, or various components thereof, may be an example of means for performing various aspects of transmission parameter signaling for higher order modulation as described herein. For example, the communications manager 720 may include a configuration manager 725, a channel measurement manager 730, a CQI manager 735, an MCS manager 740, a parameter table manager 745, or any combination thereof. Each of these components may communicate, directly or indirectly, with one another (e.g., via one or more buses).

The communications manager 720 may support wireless communications at a UE in accordance with examples as disclosed herein. The configuration manager 725 may be configured as or otherwise support a means for receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE. The channel measurement manager 730 may be configured as or otherwise support a means for determining, based on a measurement of a reference signal from the base station, a first transmission parameter for communications between the base station and the UE and a first transmission parameter index value of the transmission parameter table entry that corresponds to the first transmission parameter. The CQI manager 735 may be configured as or otherwise support a means for transmitting, to the base station, control information that includes the first number of bits that indicate the first transmission parameter index value. In some examples, the first number of bits is M bits and a value of M is indicated in the signaling to indicate the number of entries of a CQI table.

In some examples, the MCS manager 740 may be configured as or otherwise support a means for receiving, from the base station, control information that includes a second number of bits that indicates a MCS based on an entry in a MCS table that corresponds to an index value provided in the second number of bits, and where the second number of bits is N bits and a value of N is indicated in the signaling to indicate the number of entries of the MCS table. In some examples, the signaling includes an indication of a subset of entries of the transmission parameter table that are usable for the communications between the base station and the UE, and where the determining the first transmission parameter index value is based on the subset of entries of the transmission parameter table. In some examples, the indication of the subset of entries of the transmission parameter table is provided in a bitmap that indicates available entries of the transmission parameter table.

In some examples, the signaling indicates two or more different bitmaps that indicate different available entries of the transmission parameter table. In some examples, a first bitmap of the two or more different bitmaps is selected when the communications between the base station use a first frequency range, and a second bitmap of the two or more different bitmaps is selected when the communications between the base station use a second frequency range. In some examples, the bitmap is provided in radio resource control signaling, in a MAC-CE, in DCI, or any combinations thereof, and indicates entries of one or more of a CQI table or MCS table. In some examples, the transmission parameter table is a CQI table or MCS table that includes entries associated with a set of multiple modulation orders including one or more of a QPSK modulation order, a 16-QAM modulation order, a 64-QAM modulation order, a 256-QAM modulation order, a 1024-QAM modulation order, a 4096-QAM modulation order, or any combinations thereof.

Additionally or alternatively, the communications manager 720 may support wireless communications at a UE in accordance with examples as disclosed herein. In some examples, the configuration manager 725 may be configured as or otherwise support a means for receiving, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE. In some examples, the channel measurement manager 730 may be configured as or otherwise support a means for determining, based on a measurement of a reference signal from the base station, a first transmission parameter for communications between the base station and the UE and a first transmission parameter index value of the modified transmission parameter table entry that corresponds to the first transmission parameter. In some examples, the CQI manager 735 may be configured as or otherwise support a means for transmitting, to the base station, control information that includes the first transmission parameter index value.

In some examples, a predetermined number entries of the first modulation order are replaced with entries of the second modulation order, and where the second modulation order is a higher modulation order than the first modulation order. In some examples, the predetermined number of entries of the first modulation order are a subset of entries of the first modulation order. In some examples, the subset of entries of the first modulation order each have a lower spectral efficiency than one or more entries of the first modulation order that are outside of the subset of entries. In some examples, the signaling indicates a number of entries for each of two or more modulation orders that are to be replaced. In some examples, the set of multiple entries that are to be modified are provided for a CQI table, and where a corresponding set of multiple entries for a MCS table are also modified based on the set of multiple entries for the CQI table.

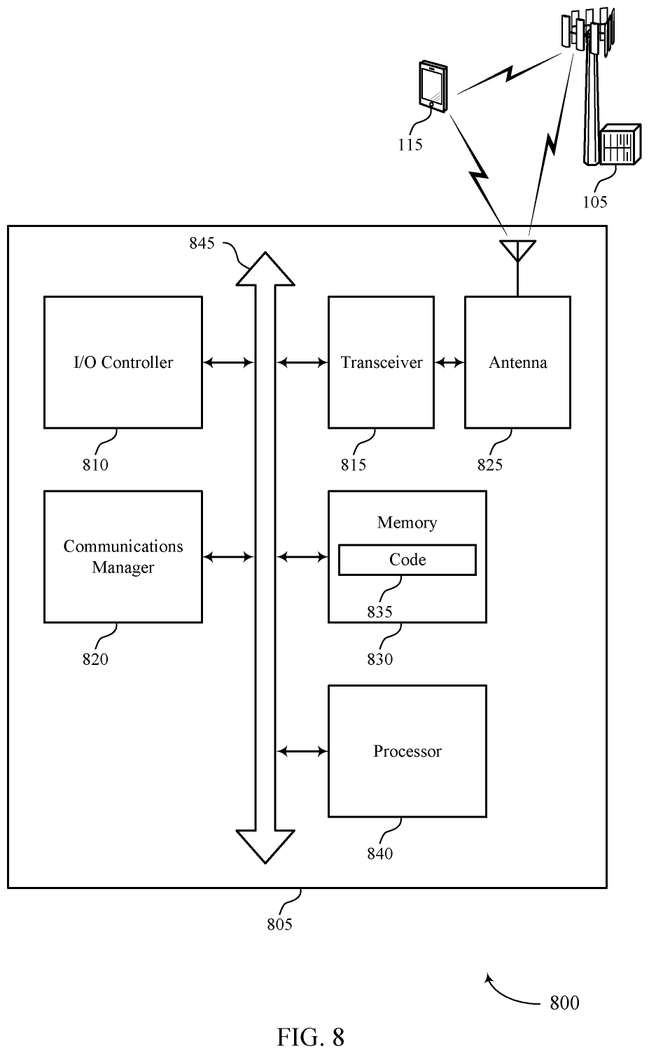

FIG. 8 shows a diagram of a system 800 including a device 805 that supports transmission parameter signaling for higher order modulation in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting transmission parameter signaling for higher order modulation). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE. The communications manager 820 may be configured as or otherwise support a means for determining, based on a measurement of a reference signal from the base station, a first transmission parameter for communications between the base station and the UE and a first transmission parameter index value of the transmission parameter table entry that corresponds to the first transmission parameter. The communications manager 820 may be configured as or otherwise support a means for transmitting, to the base station, control information that includes the first number of bits that indicate the first transmission parameter index value.

Additionally or alternatively, the communications manager 820 may support wireless communications at a UE in accordance with examples as disclosed herein. For example, the communications manager 820 may be configured as or otherwise support a means for receiving, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE. The communications manager 820 may be configured as or otherwise support a means for determining, based on a measurement of a reference signal from the base station, a first transmission parameter for communications between the base station and the UE and a first transmission parameter index value of the modified transmission parameter table entry that corresponds to the first transmission parameter. The communications manager 820 may be configured as or otherwise support a means for transmitting, to the base station, control information that includes the first transmission parameter index value.

By including or configuring the communications manager 820 in accordance with examples as described herein, the device 805 may support techniques for transmission parameter signaling for higher modulation orders that may provide modulation order and coding rates that are relatively finely tuned for channel conditions, which may provide improved communication reliability, reduced latency, improved user experience, reduced power consumption, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of transmission parameter signaling for higher order modulation as described herein, or the processor 840 and the memory 830 may be otherwise configured to perform or support such operations.

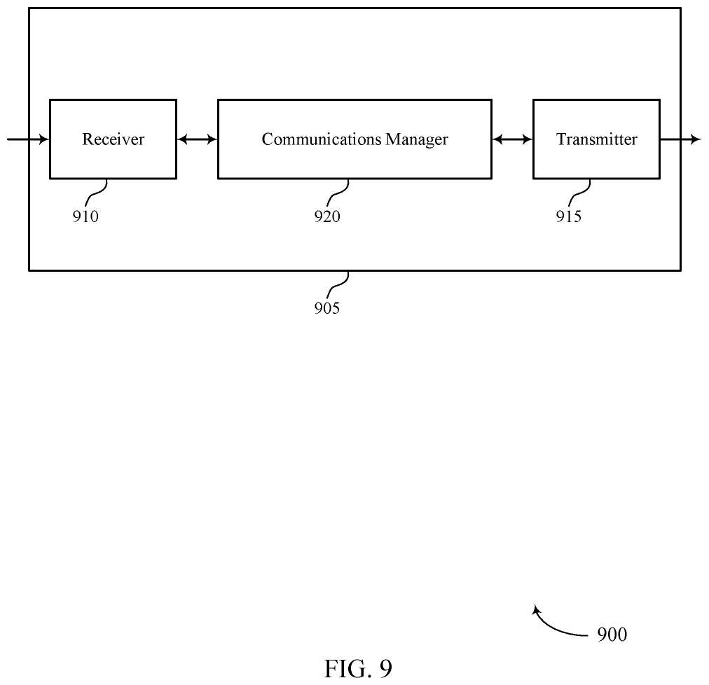

FIG. 9 shows a block diagram 900 of a device 905 that supports transmission parameter signaling for higher order modulation in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to transmission parameter signaling for higher order modulation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to transmission parameter signaling for higher order modulation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of transmission parameter signaling for higher order modulation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order. The communications manager 920 may be configured as or otherwise support a means for receiving, from the UE, control information that indicates the transmission parameter index value. The communications manager 920 may be configured as or otherwise support a means for determining, based on a transmission parameter indicated by the transmission parameter index value and a modulation order associated with the transmission parameter index value, a first transmission parameter for communications between the base station and the UE.

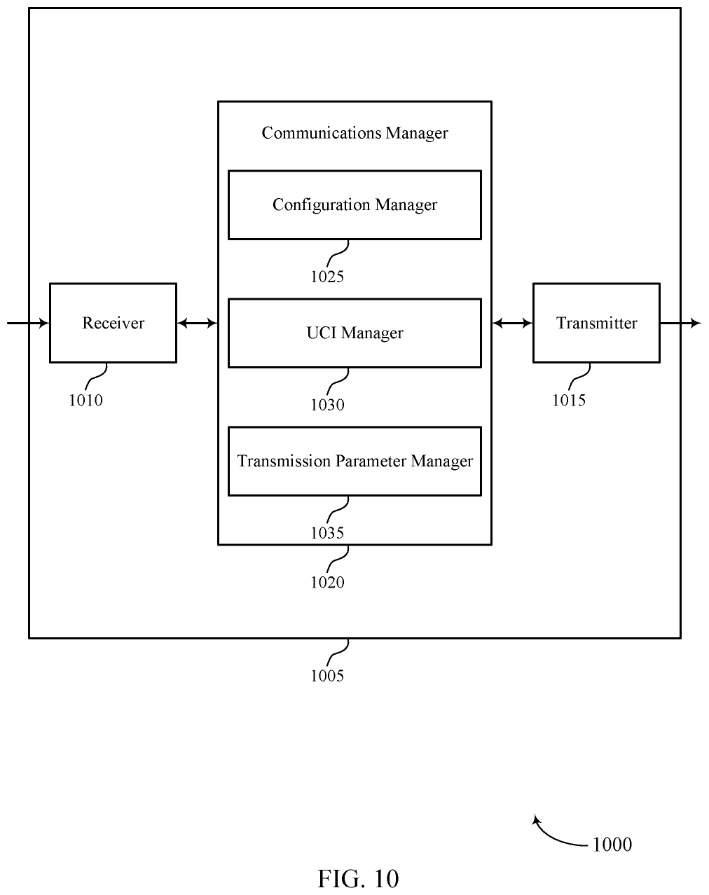

FIG. 10 shows a block diagram 1000 of a device 1005 that supports transmission parameter signaling for higher order modulation in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to transmission parameter signaling for higher order modulation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to transmission parameter signaling for higher order modulation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of transmission parameter signaling for higher order modulation as described herein. For example, the communications manager 1020 may include a configuration manager 1025, a UCI manager 1030, a transmission parameter manager 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The configuration manager 1025 may be configured as or otherwise support a means for transmitting, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order. The UCI manager 1030 may be configured as or otherwise support a means for receiving, from the UE, control information that indicates the transmission parameter index value. The transmission parameter manager 1035 may be configured as or otherwise support a means for determining, based on a transmission parameter indicated by the transmission parameter index value and a modulation order associated with the transmission parameter index value, a first transmission parameter for communications between the base station and the UE.

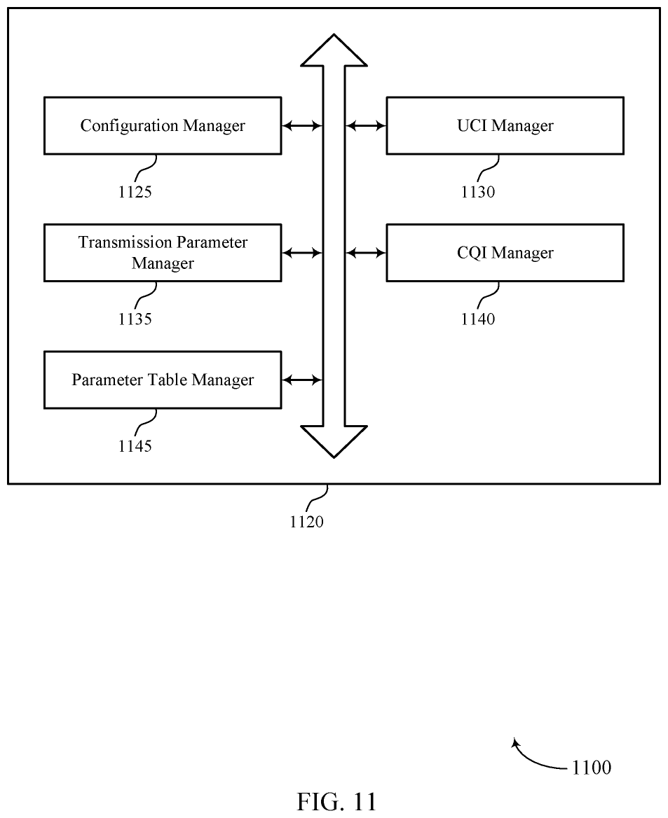

FIG. 11 shows a block diagram 1100 of a communications manager 1120 that supports transmission parameter signaling for higher order modulation in accordance with aspects of the present disclosure. The communications manager 1120 may be an example of aspects of a communications manager 920, a communications manager 1020, or both, as described herein. The communications manager 1120, or various components thereof, may be an example of means for performing various aspects of transmission parameter signaling for higher order modulation as described herein. For example, the communications manager 1120 may include a configuration manager 1125, a UCI manager 1130, a transmission parameter manager 1135, a CQI manager 1140, a parameter table manager 1145, or any combination thereof. Each of these components may communicate, directly or indirectly, with one another (e.g., via one or more buses).

The communications manager 1120 may support wireless communications at a base station in accordance with examples as disclosed herein. The configuration manager 1125 may be configured as or otherwise support a means for transmitting, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order. The UCI manager 1130 may be configured as or otherwise support a means for receiving, from the UE, control information that indicates the transmission parameter index value. The transmission parameter manager 1135 may be configured as or otherwise support a means for determining, based on a transmission parameter indicated by the transmission parameter index value and a modulation order associated with the transmission parameter index value, a first transmission parameter for communications between the base station and the UE.

In some examples, where the first number of bits is based on one or more of a size of the transmission parameter table or a number of entries of the transmission parameter table that are configured for the communications between the base station and the UE. In some examples, the first number of bits is M bits and a value of M is indicated in the configuration information to indicate the number of entries of a CQI table, and wherein a second number of bits is N bits used to indicate an entry in a MCS table, and a value of N is further indicated in the configuration information. In some examples, the signaling includes an indication of a subset of entries of the transmission parameter table that are usable for the communications between the base station and the UE, and where the transmission parameter index value is based on the subset of entries of the transmission parameter table.

In some examples, the indication of the subset of entries of the transmission parameter table is provided in a bitmap that indicates available entries of the transmission parameter table. In some examples, a first bitmap of two or more different bitmaps is selected when the communications between the base station use a first frequency range, and a second bitmap of the two or more different bitmaps is selected when the communications between the base station use a second frequency range.

In some examples, the one or more modifications to the transmission parameter table include a predetermined number of entries of the first modulation order are replaced with entries of the second modulation order, and where the second modulation order is a higher modulation order than the first modulation order. In some examples, the predetermined number of entries of the first modulation order are a subset of entries of the first modulation order. In some examples, the subset of entries of the first modulation order each have a lower spectral efficiency than one or more entries of the first modulation order that are outside of the subset of entries.

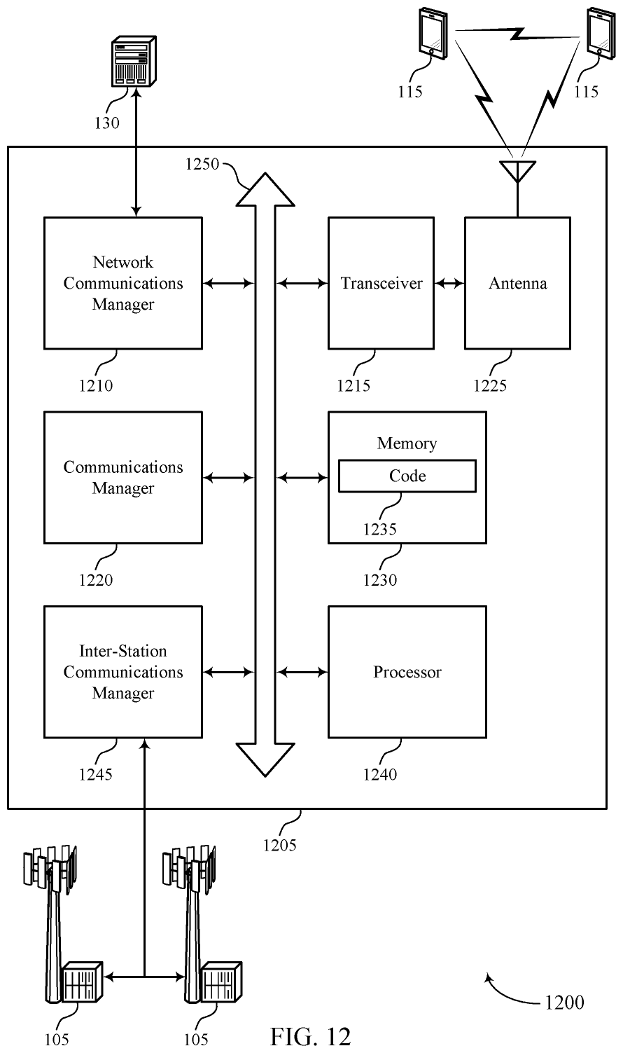

FIG. 12 shows a diagram of a system 1200 including a device 1205 that supports transmission parameter signaling for higher order modulation in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting transmission parameter signaling for higher order modulation). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order. The communications manager 1220 may be configured as or otherwise support a means for receiving, from the UE, control information that indicates the transmission parameter index value. The communications manager 1220 may be configured as or otherwise support a means for determining, based on a transmission parameter indicated by the transmission parameter index value and a modulation order associated with the transmission parameter index value, a first transmission parameter for communications between the base station and the UE.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of transmission parameter signaling for higher order modulation as described herein, or the processor 1240 and the memory 1230 may be otherwise configured to perform or support such operations.

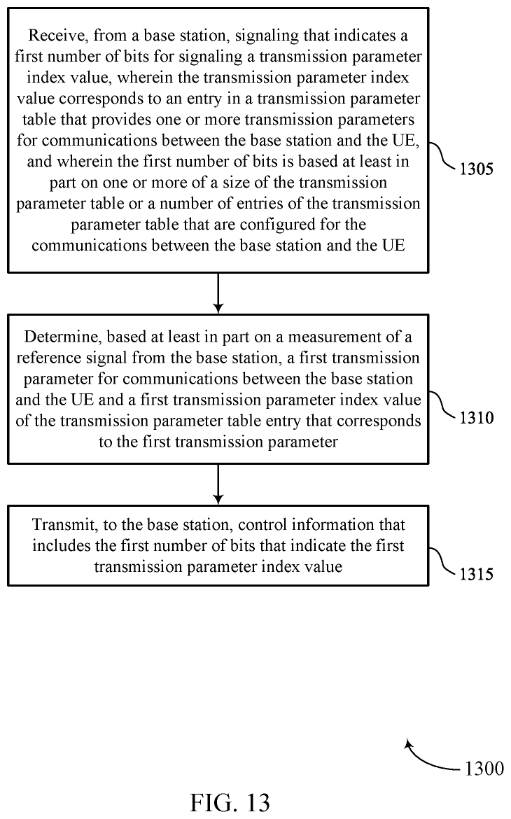

FIG. 13 shows a flowchart illustrating a method 1300 that supports transmission parameter signaling for higher order modulation in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE. The operations of 1305 may be performed in accordance with examples as disclosed herein. In some examples, aspects of the operations of 1305 may be performed by a configuration manager 725 as described with reference to FIG. 7.

At 1310, the method may include determining, based on a measurement of a reference signal from the base station, a first transmission parameter for communications between the base station and the UE and a first transmission parameter index value of the transmission parameter table entry that corresponds to the first transmission parameter. The operations of 1310 may be performed in accordance with examples as disclosed herein. In some examples, aspects of the operations of 1310 may be performed by a channel measurement manager 730 as described with reference to FIG. 7.

At 1315, the method may include transmitting, to the base station, control information that includes the first number of bits that indicate the first transmission parameter index value. The operations of 1315 may be performed in accordance with examples as disclosed herein. In some examples, aspects of the operations of 1315 may be performed by a CQI manager 735 as described with reference to FIG. 7.

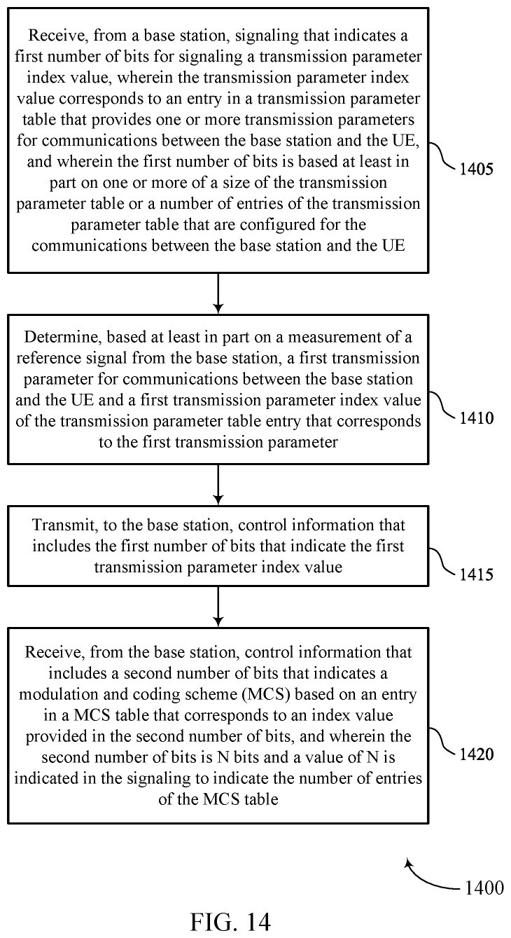

FIG. 14 shows a flowchart illustrating a method 1400 that supports transmission parameter signaling for higher order modulation in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, signaling that indicates a first number of bits for signaling a transmission parameter index value, where the transmission parameter index value corresponds to an entry in a transmission parameter table that provides one or more transmission parameters for communications between the base station and the UE, and where the first number of bits is based on one or more of a size of the transmission parameter table or a number of entries of the transmission parameter table that are configured for the communications between the base station and the UE. The operations of 1405 may be performed in accordance with examples as disclosed herein. In some examples, aspects of the operations of 1405 may be performed by a configuration manager 725 as described with reference to FIG. 7.

At 1410, the method may include determining, based on a measurement of a reference signal from the base station, a first transmission parameter for communications between the base station and the UE and a first transmission parameter index value of the transmission parameter table entry that corresponds to the first transmission parameter. The operations of 1410 may be performed in accordance with examples as disclosed herein. In some examples, aspects of the operations of 1410 may be performed by a channel measurement manager 730 as described with reference to FIG. 7.

At 1415, the method may include transmitting, to the base station, control information that includes the first number of bits that indicate the first transmission parameter index value. The operations of 1415 may be performed in accordance with examples as disclosed herein. In some examples, aspects of the operations of 1415 may be performed by a CQI manager 735 as described with reference to FIG. 7.

At 1420, the method may include receiving, from the base station, control information that includes a second number of bits that indicates a modulation and coding scheme (MCS) based on an entry in a MCS table that corresponds to an index value provided in the second number of bits, and where the second number of bits is N bits and a value of N is indicated in the signaling to indicate the number of entries of the MCS table. The operations of 1420 may be performed in accordance with examples as disclosed herein. In some examples, aspects of the operations of 1420 may be performed by an MCS manager 740 as described with reference to FIG. 7.

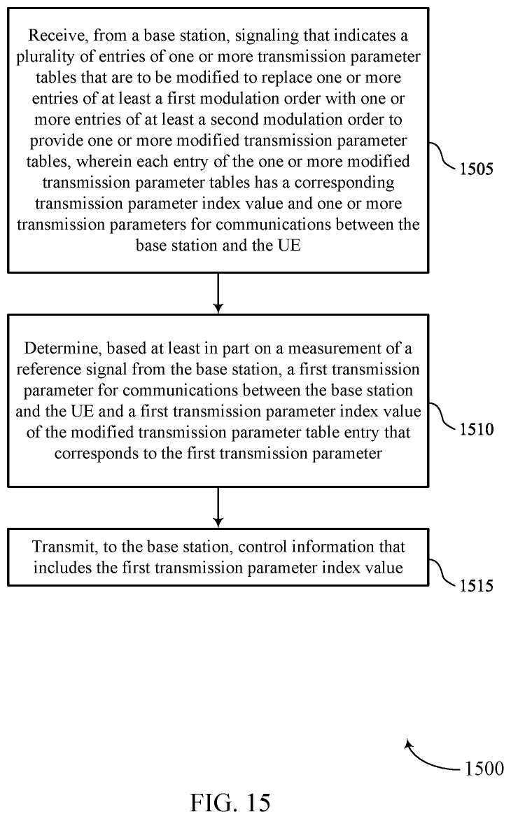

FIG. 15 shows a flowchart illustrating a method 1500 that supports transmission parameter signaling for higher order modulation in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, signaling that indicates a set of multiple entries of one or more transmission parameter tables that are to be modified to replace one or more entries of at least a first modulation order with one or more entries of at least a second modulation order to provide one or more modified transmission parameter tables, where each entry of the one or more modified transmission parameter tables has a corresponding transmission parameter index value and one or more transmission parameters for communications between the base station and the UE. The operations of 1505 may be performed in accordance with examples as disclosed herein. In some examples, aspects of the operations of 1505 may be performed by a configuration manager 725 as described with reference to FIG. 7.

At 1510, the method may include determining, based on a measurement of a reference signal from the base station, a first transmission parameter for communications between the base station and the UE and a first transmission parameter index value of the modified transmission parameter table entry that corresponds to the first transmission parameter. The operations of 1510 may be performed in accordance with examples as disclosed herein. In some examples, aspects of the operations of 1510 may be performed by a channel measurement manager 730 as described with reference to FIG. 7.

At 1515, the method may include transmitting, to the base station, control information that includes the first transmission parameter index value. The operations of 1515 may be performed in accordance with examples as disclosed herein. In some examples, aspects of the operations of 1515 may be performed by a CQI manager 735 as described with reference to FIG. 7.

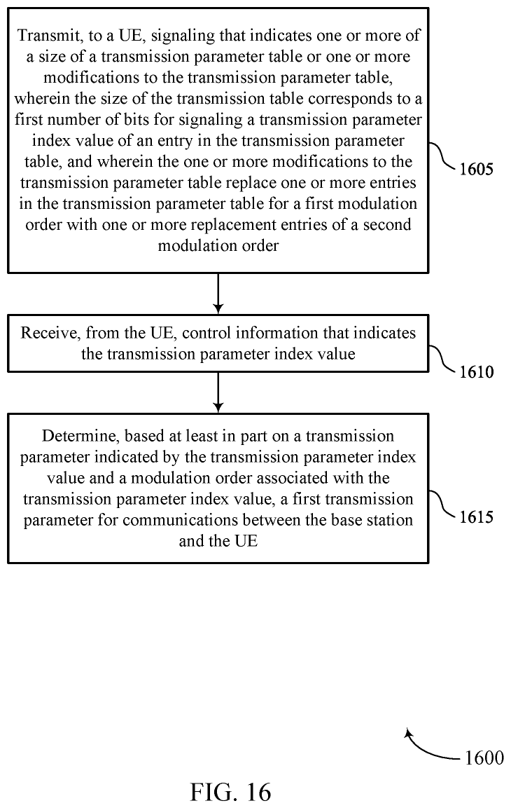

FIG. 16 shows a flowchart illustrating a method 1600 that supports transmission parameter signaling for higher order modulation in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, signaling that indicates one or more of a size of a transmission parameter table or one or more modifications to the transmission parameter table, where the size of the transmission table corresponds to a first number of bits for signaling a transmission parameter index value of an entry in the transmission parameter table, and where the one or more modifications to the transmission parameter table replace one or more entries in the transmission parameter table for a first modulation order with one or more replacement entries of a second modulation order. The operations of 1605 may be performed in accordance with examples as disclosed herein. In some examples, aspects of the operations of 1605 may be performed by a configuration manager 1125 as described with reference to FIG. 11.

At 1610, the method may include receiving, from the UE, control information that indicates the transmission parameter index value. The operations of 1610 may be performed in accordance with examples as disclosed herein. In some examples, aspects of the operations of 1610 may be performed by a UCI manager 1130 as described with reference to FIG. 11.

At 1615, the method may include determining, based on a transmission parameter indicated by the transmission parameter index value and a modulation order associated with the transmission parameter index value, a first transmission parameter for communications between the base station and the UE. The operations of 1615 may be performed in accordance with examples as disclosed herein. In some examples, aspects of the operations of 1615 may be performed by a transmission parameter manager 1135 as described with reference to FIG. 11.

The following provides an overview of aspects of the present disclosure:

Aspect 1: A method for wireless communications at a UE, comprising: receiving, from a base station, signaling that indicates a first number of bits for signaling a transmission parameter index value, wherein the transmission parameter index value corresponds to an entry in a transmission parameter table that provides one or more transmission parameters for communications between the base station and the UE, and wherein the first number of bits is based at least in part on one or more of a size of the transmission parameter table or a number of entries of the transmission parameter table that are configured for the communications between the base station and the UE; determining, based at least in part on a measurement of a reference signal from the base station, a first transmission parameter for communications between the base station and the UE and a first transmission parameter index value of the transmission parameter table entry that corresponds to the first transmission parameter; and transmitting, to the base station, control information that includes the first number of bits that indicate the first transmission parameter index value.

Aspect 2: The method of aspect 1, wherein the first number of bits is M bits and a value of M is indicated in the signaling to indicate the number of entries of a channel quality indicator (CQI) table.

Aspect 3: The method of any of aspects 1 through 2, further comprising: receiving, from the base station, control information that includes a second number of bits that indicates a modulation and coding scheme (MCS) based on an entry in a MCS table that corresponds to an index value provided in the second number of bits, and wherein the second number of bits is N bits and a value of N is indicated in the signaling to indicate the number of entries of the MCS table.

Aspect 4: The method of any of aspects 1 through 3, wherein the signaling includes an indication of a subset of entries of the transmission parameter table that are usable for the communications between the base station and the UE, and wherein the determining the first transmission parameter index value is based at least in part on the subset of entries of the transmission parameter table.

Aspect 5: The method of any of aspects 1 through 4, wherein the indication of the subset of entries of the transmission parameter table is provided in a bitmap that indicates available entries of the transmission parameter table.

Aspect 6: The method of aspect 5, wherein the signaling indicates two or more different bitmaps that indicate different available entries of the transmission parameter table.

Aspect 7: The method of aspect 6, wherein a first bitmap of the two or more different bitmaps is selected when the communications between the base station use a first frequency range, and a second bitmap of the two or more different bitmaps is selected when the communications between the base station use a second frequency range.

Aspect 8: The method of any of aspects 5 through 7, wherein the bitmap is provided in radio resource control signaling, in a medium access control (MAC) control element, in DCI, or any combinations thereof, and indicates entries of one or more of a channel quality indicator (CQI) table or modulation and coding scheme (MCS) table.

Aspect 9: The method of any of aspects 1 through 8, wherein the transmission parameter table is a channel quality indicator (CQI) table or modulation and coding scheme (MCS) table that includes entries associated with a plurality of modulation orders including one or more of a quadrature phase shift keying (QPSK) modulation order, a 16 quadrature amplitude multiplexing (QAM) modulation order, a 16QAM modulation order, a 64QAM modulation order, a 256QAM modulation order, a 1024QAM modulation order, a 4096QAM modulation order, or any combinations thereof.

Aspect 10: A method for wireless communications at a UE, comprising: receiving, from a base station, signaling that indicates a plurality of entries of one or more transmission parameter tables that are to be modified to replace one or more entries of at least a first modulation order with one or more entries of at least a second modulation order to provide one or more modified transmission parameter tables, wherein each entry of the one or more modified transmission parameter tables has a corresponding transmission parameter index value and one or more transmission parameters for communications between the base station and the UE; determining, based at least in part on a measurement of a reference signal from the base station, a first transmission parameter for communications between the base station and the UE and a first transmission parameter index value of the modified transmission parameter table entry that corresponds to the first transmission parameter; and transmitting, to the base station, control information that includes the first transmission parameter index value.

Aspect 11: The method of aspect 10, wherein a predetermined number entries of the first modulation order are replaced with entries of the second modulation order, and wherein the second modulation order is a higher modulation order than the first modulation order.

Aspect 12: The method of aspect 11, wherein the predetermined number of entries of the first modulation order are a subset of entries of the first modulation order.

Aspect 13: The method of aspect 12, wherein the subset of entries of the first modulation order each have a lower spectral efficiency than one or more entries of the first modulation order that are outside of the subset of entries.

Aspect 14: The method of any of aspects 10 through 13, wherein the signaling indicates a number of entries for each of two or more modulation orders that are to be replaced.

Aspect 15: The method of any of aspects 10 through 14, wherein the plurality of entries that are to be modified are provided for a channel quality indicator (CQI) table, and where a corresponding plurality of entries for a modulation and coding scheme (MCS) table are also modified based at least in part on the plurality of entries for the CQI table.

Aspect 16: A method for wireless communications at a base station, comprising: transmitting, to a UE, signaling that indicates one or more of a size of a transmission parameter table or one or more modifications to the transmission parameter table, wherein the size of the transmission table corresponds to a first number of bits for signaling a transmission parameter index value of an entry in the transmission parameter table, and wherein the one or more modifications to the transmission parameter table replace one or more entries in the transmission parameter table for a first modulation order with one or more replacement entries of a second modulation order; receiving, from the UE, control information that indicates the transmission parameter index value; and determining, based at least in part on a transmission parameter indicated by the transmission parameter index value and a modulation order associated with the transmission parameter index value, a first transmission parameter for communications between the base station and the UE.

Aspect 17: The method of aspect 16, wherein the first number of bits is based at least in part on one or more of a size of the transmission parameter table or a number of entries of a channel quality indicator (CQI) table, and wherein a second number of bits is N bits used to indicate an entry in a modulation and coding scheme (MCS) table, and a value of N is further indicated in the configuration information.

Aspect 18: The method of any of aspects 16 through 17, wherein the first number of bits is M bits and a value of M is indicated in the configuration information to indicate the number of entries of a channel quality indicator (CQI) table, and wherein a second number of bits is N bits used to indicate an entry in a modulation and coding scheme (MCS) table, and a value of N is further indicated in the configuration information.

Aspect 19: The method of any of aspects 16 through 18, wherein the signaling includes an indication of a subset of entries of the transmission parameter table that are usable for the communications between the base station and the UE, and wherein the transmission parameter index value is based at least in part on the subset of entries of the transmission parameter table.

Aspect 20: The method of aspect 19, wherein the indication of the subset of entries of the transmission parameter table is provided in a bitmap that indicates available entries of the transmission parameter table.

Aspect 21: The method of aspect 20, wherein a first bitmap of two or more different bitmaps is selected when the communications between the base station use a first frequency range, and a second bitmap of the two or more different bitmaps is selected when the communications between the base station use a second frequency range.

Aspect 22: The method of any of aspects 16 through 21, wherein the one or more modifications to the transmission parameter table include a predetermined number of entries of the first modulation order are replaced with entries of the second modulation order, and wherein the second modulation order is a higher modulation order than the first modulation order.

Aspect 23: The method of aspect 22, wherein the predetermined number of entries of the first modulation order are a subset of entries of the first modulation order.

Aspect 24: The method of aspect 23, wherein the subset of entries of the first modulation order each have a lower spectral efficiency than one or more entries of the first modulation order that are outside of the subset of entries.

Aspect 25: An apparatus for wireless communications at a UE, comprising a processor; memory coupled with the processor; and instructions stored in the memory and executable by the processor to cause the apparatus to perform a method of any of aspects 1 through 9.

Aspect 26: An apparatus for wireless communications at a UE, comprising at least one means for performing a method of any of aspects 1 through 9.

Aspect 27: A non-transitory computer-readable medium storing code for wireless communications at a UE, the code comprising instructions executable by a processor to perform a method of any of aspects 1 through 9.

Aspect 28: An apparatus for wireless communications at a UE, comprising a processor; memory coupled with the processor; and instructions stored in the memory and executable by the processor to cause the apparatus to perform a method of any of aspects 10 through 15.

Aspect 29: An apparatus for wireless communications at a UE, comprising at least one means for performing a method of any of aspects 10 through 15.

Aspect 30: A non-transitory computer-readable medium storing code for wireless communications at a UE, the code comprising instructions executable by a processor to perform a method of any of aspects 10 through 15.

Aspect 31: An apparatus for wireless communications at a base station, comprising a processor; memory coupled with the processor; and instructions stored in the memory and executable by the processor to cause the apparatus to perform a method of any of aspects 16 through 24.

Aspect 32: An apparatus for wireless communications at a base station, comprising at least one means for performing a method of any of aspects 16 through 24.

Aspect 33: A non-transitory computer-readable medium storing code for wireless communications at a base station, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, signaling that indicates a first number of bits for signaling a transmission parameter index value, wherein the transmission parameter index value corresponds to an entry in a transmission parameter table that provides one or more transmission parameters for communications between the base station and the UE, and wherein the first number of bits is based at least in part on one or more of a size of the transmission parameter table or a number of entries of the transmission parameter table that are configured for the communications between the base station and the UE;
determining, based at least in part on a measurement of a reference signal from the base station, a first transmission parameter for communications between the base station and the UE and a first transmission parameter index value of the transmission parameter table entry that corresponds to the first transmission parameter; and
transmitting, to the base station, control information that includes the first number of bits that indicate the first transmission parameter index value.

2. The method of claim 1, wherein the first number of bits is M bits and a value of M is indicated in the signaling to indicate the number of entries of a channel quality indicator (CQI) table.

3. The method of claim 1, further comprising:
receiving, from the base station, control information that includes a second number of bits that indicates a modulation and coding scheme (MCS) based on an entry in a MCS table that corresponds to an index value provided in the second number of bits, and wherein the second number of bits is N bits and a value of N is indicated in the signaling to indicate the number of entries of the MCS table.

4. The method of claim 1, wherein the signaling includes an indication of a subset of entries of the transmission parameter table that are usable for the communications between the base station and the UE, and wherein the determining the first transmission parameter index value is based at least in part on the subset of entries of the transmission parameter table.

5. The method of claim 4, wherein the indication of the subset of entries of the transmission parameter table is provided in a bitmap that indicates available entries of the transmission parameter table.

6. The method of claim 5, wherein the signaling indicates two or more different bitmaps that indicate different available entries of the transmission parameter table.

7. The method of claim 6, wherein a first bitmap of the two or more different bitmaps is selected when the communications between the base station use a first frequency range, and a second bitmap of the two or more different bitmaps is selected when the communications between the base station use a second frequency range.

8. The method of claim 5, wherein the bitmap is provided in radio resource control signaling, in a medium access control (MAC) control element, in downlink control information (DCI), or any combinations thereof, and indicates entries of one or more of a channel quality indicator (CQI) table or modulation and coding scheme (MCS) table.

9. The method of claim 1, wherein the transmission parameter table is a channel quality indicator (CQI) table or modulation and coding scheme (MCS) table that includes entries associated with a plurality of modulation orders including one or more of a quadrature phase shift keying (QPSK) modulation order, a 16 quadrature amplitude multiplexing (QAM) modulation order, a 64QAM modulation order, a 256QAM modulation order, a 1024QAM modulation order, a 4096QAM modulation order, or any combinations thereof.

10. A method for wireless communications at a user equipment (UE), comprising:
receiving, from a base station, signaling that indicates a plurality of entries of one or more transmission parameter tables that are to be modified to replace one or more entries of at least a first modulation order with one or more entries of at least a second modulation order to provide one or more modified transmission parameter tables, wherein each entry of the one or more modified transmission parameter tables has a corresponding transmission parameter index value and one or more transmission parameters for communications between the base station and the UE;
determining, based at least in part on a measurement of a reference signal from the base station, a first transmission parameter for communications between the base station and the UE and a first transmission parameter index value of the modified transmission parameter table entry that corresponds to the first transmission parameter; and
transmitting, to the base station, control information that includes the first transmission parameter index value.

11. The method of claim 10, wherein a predetermined number entries of the first modulation order are replaced with entries of the second modulation order, and wherein the second modulation order is a higher modulation order than the first modulation order.

12. The method of claim 11, wherein the predetermined number of entries of the first modulation order are a subset of entries of the first modulation order.

13. The method of claim 12, wherein the subset of entries of the first modulation order each have a lower spectral efficiency than one or more entries of the first modulation order that are outside of the subset of entries.

14. The method of claim 10, wherein the signaling indicates a number of entries for each of two or more modulation orders that are to be replaced.

15. The method of claim 10, wherein the plurality of entries that are to be modified are provided for a channel quality indicator (CQI) table, and where a corresponding plurality of entries for a modulation and coding scheme (MCS) table are also modified based at least in part on the plurality of entries for the CQI table.

16. A method for wireless communications at a base station, comprising:
transmitting, to a user equipment (UE), signaling that indicates one or more of a size of a transmission parameter table or one or more modifications to the transmission parameter table, wherein the size of the transmission parameter table corresponds to a first number of bits for signaling a transmission parameter index value of an entry in the transmission parameter table, and wherein the one or more modifications to the transmission parameter table replace one or more entries in the transmission parameter table for a first modulation order with one or more replacement entries of a second modulation order;
receiving, from the UE, control information that indicates the transmission parameter index value; and
determining, based at least in part on a transmission parameter indicated by the transmission parameter index value and a modulation order associated with the transmission parameter index value, a first transmission parameter for communications between the base station and the UE.

17. The method of claim 16, wherein the first number of bits is based at least in part on one or more of a size of the transmission parameter table or a number of entries of the transmission parameter table that are configured for the communications between the base station and the UE.

18. The method of claim 16, wherein the first number of bits is M bits and a value of M is indicated in configuration information to indicate the number of entries of a channel quality indicator (CQI) table, and wherein a second number of bits is N bits used to indicate an entry in a modulation and coding scheme (MCS) table, and a value of N is further indicated in the configuration information.

19. The method of claim 16, wherein the signaling includes an indication of a subset of entries of the transmission parameter table that are usable for the communications between the base station and the UE, and wherein the transmission parameter index value is based at least in part on the subset of entries of the transmission parameter table.

20. The method of claim 19, wherein the indication of the subset of entries of the transmission parameter table is provided in a bitmap that indicates available entries of the transmission parameter table.

21. The method of claim 20, wherein a first bitmap of two or more different bitmaps is selected when the communications between the base station use a first frequency range, and a second bitmap of the two or more different bitmaps is selected when the communications between the base station use a second frequency range.

22. The method of claim 16, wherein the one or more modifications to the transmission parameter table include a predetermined number of entries of the first modulation order are replaced with entries of the second modulation order, and wherein the second modulation order is a higher modulation order than the first modulation order.

23. The method of claim 22, wherein the predetermined number of entries of the first modulation order are a subset of entries of the first modulation order.

24. The method of claim 23, wherein the subset of entries of the first modulation order each have a lower spectral efficiency than one or more entries of the first modulation order that are outside of the subset of entries.

25. An apparatus for wireless communications at a user equipment (UE), comprising:
a processor;
memory coupled with the processor; and
instructions stored in the memory and executable by the processor to cause the apparatus to:
receive, from a base station, signaling that indicates a first number of bits for signaling a transmission parameter index value, wherein the transmission parameter index value corresponds to an entry in a transmission parameter table that provides one or more transmission parameters for communications between the base station and the UE, and wherein the first number of bits is based at least in part on one or more of a size of the transmission parameter table or a number of entries of the transmission parameter table that are configured for the communications between the base station and the UE;
determine, based at least in part on a measurement of a reference signal from the base station, a first transmission parameter for communications between the base station and the UE and a first transmission parameter index value of the transmission parameter table entry that corresponds to the first transmission parameter; and
transmit, to the base station, control information that includes the first number of bits that indicate the first transmission parameter index value.

26. The apparatus of claim 25, wherein the first number of bits is M bits and a value of M is indicated in the signaling to indicate the number of entries of a channel quality indicator (CQI) table.

27. The apparatus of claim 25, wherein the instructions are further executable by the processor to cause the apparatus to:
receive, from the base station, control information that includes a second number of bits that indicates a modulation and coding scheme (MCS) based on an entry in a MCS table that corresponds to an index value provided in the second number of bits, and wherein the second number of bits is N bits and a value of N is indicated in the signaling to indicate the number of entries of the MCS table.

28. An apparatus for wireless communications at a user equipment (UE), comprising:
a processor;
memory coupled with the processor; and
instructions stored in the memory and executable by the processor to cause the apparatus to:
receive, from a base station, signaling that indicates a plurality of entries of one or more transmission parameter tables that are to be modified to replace one or more entries of at least a first modulation order with one or more entries of at least a second modulation order to provide one or more modified transmission parameter tables, wherein each entry of the one or more modified transmission parameter tables has a corresponding transmission parameter index value and one or more transmission parameters for communications between the base station and the UE;
determine, based at least in part on a measurement of a reference signal from the base station, a first transmission parameter for communications between the base station and the UE and a first transmission parameter index value of the modified transmission parameter table entry that corresponds to the first transmission parameter; and
transmit, to the base station, control information that includes the first transmission parameter index value.

29. The apparatus of claim 28, wherein a predetermined number entries of the first modulation order are replaced with entries of the second modulation order, and wherein the second modulation order is a higher modulation order than the first modulation order.

30. The apparatus of claim 28, wherein the plurality of entries that are to be modified are provided for a channel quality indicator (CQI) table, and where a corresponding plurality of entries for a modulation and coding scheme (MCS) table are also modified based at least in part on the plurality of entries for the CQI table.
